(19) United States
(12) Patent Application Publication
(10) Pub. No.: US 2003/0172298 A1
(43) Pub. Date: Sep. 11, 2003

(54) Method and system for maintaining secure access to web server services using server-delegated permissions

(76) Inventors: Carl A. Gunter, Philadelphia, PA (US); Michael C. Berry, Philadelphia, PA (US); Robert Levas, Mount Laurel, NJ (US)

Correspondence Address: Daniel H. Golub, 1701 Market Street, Philadelphia, PA, 19103, US

(21) Appl. No.: 10/090,681

(22) Filed: Mar. 5, 2002

(51) Int. Cl. G06F 7/00

(52) U.S. Cl. 713/201

(57) ABSTRACT

A method and system for manipulating permissions are disclosed. A first permission, including a label related to a service accessible via a service web server, is maintained at a permission web server. A second user is provided access to the first permission upon his authenticating to the permission web server and is provided a permission to access the service. The second user will be given access to the service, upon his requesting access to the service and supplying the permission, if the digital signatures in the permission are positively verified. The second user may, instead of seeking access to the service himself, delegate permission to do so to a subsequent user.

### CROSS REFERENCE TO RELATED APPLICATIONS

Not applicable.

### STATEMENT REGARDING FEDERALLY SPONSORED RESEARCH

Not applicable.

### BACKGROUND OF THE INVENTION

1. Field of the Invention

The present invention is directed generally to methods and systems for maintaining secure access to services maintained on web servers.

2. Description of the Background

Public key cryptographic systems offer a number of advantages over the use of shared secrets such as passwords. For example, private keys cannot be guessed, and public keys can be sent in cleartext over the Internet. Chains of public key certificates can be used to bind names to keys based on a hierarchical or web-like system of authority. This allows parties to use public keys very broadly. For example, public key certificates are widely used on the World Wide Web (WWW) to provide authority for the binding of domain names to keys as part of the SSL protocol. This enables clients to authenticate web servers in sensitive exchanges such as credit card purchases. The SSL protocol also allows for client public key authentication, permitting the client to supply a public key certificate and authenticate by showing knowledge of the appropriate private key.

While public key certificates that bind a name to a key are very advantageous, it is often desirable to offer another form of certificate, called an attribute certificate, that binds general properties to a key or name. For example, an attribute certificate may indicate that a public key belongs to an individual who is an employee of a company. This information can be included in a public key certificate, but doing so may introduce undesirable maintenance requirements for the public key certificate. For example, if an individual has a certificate binding his name to a key and also indicating that he is the employee of a company, then the certificate will need to be revoked if he leaves the company. If instead he had a public key certificate binding his name to a key and, in addition, an attribute certificate indicating that his key belonged to an individual working for the company in question, then only the attribute certificate would need to be revoked if he left the company. The situation is even clearer when the attribute certificate is intended for a specific or short-lived purpose like a permission to access a resource for a limited time. If each such permission had to be included in the public key certificate then this certificate would need to be changed very frequently.

Formats and verification rules for attribute certificates have been described in a number of major standards. There are also sophisticated systems available for creating chains of certificates for access to a resource and verifying that a proper sequence of delegations leads from an authority entitled to grant and delegate a permission via a sequence of well-formed delegations to the party requesting the resource.

Despite numerous advantages of public key certificates and their use in connection with attribute certificates, their use by non-servers on the web is comparatively limited. To enable the use of attribute certificates on the web, a number of support functions are needed to create, distribute, and delegate permissions using typical web browsers, web servers, and Internet messaging systems.

### BRIEF SUMMARY OF THE INVENTION

The current invention addresses the needs present in the prior art.

The present invention is directed to a method and system of providing secure access to a service on a service web server. A first permission is maintained at a permission web server. The first permission includes a label related to the service and a digital signature of a first user. A second user is provided access to the first permission upon the second user authenticating to the permission web server. The second user is provided a permission that includes the first permission and a permission link that includes the label and a digital signature of the permission web server. A request to access the service is received at the service web server from the second user, as well as the permission. The digital signature of the permission web server and the digital signature of the first user in the permission are verified. The second user is provided access to the service if the verification produces a positive result. Instead of, or in addition to, seeking access to the service himself, the second user may delegate permission to access the service to a subsequent user.

### BRIEF DESCRIPTION OF THE DRAWINGS

The accompanying drawings, wherein like referenced numerals are employed to designate like parts or steps, are included to provide a further understanding of the invention, are incorporated and constitute a part of this specification, and illustrate embodiments of the invention that together with the description serve to explain the principles of the invention.

In the drawings:

FIG. 1A illustrates a message sequence chart of a preferred embodiment of the present invention.

FIG. 1B illustrates a system of one embodiment of the present invention.

FIG. 1C illustrates a message sequence chart of a preferred embodiment of the present invention.

FIG. 1D illustrates exemplary data structures for two permissions.

FIG. 1E provides an example of a web page that allows a user to configure a resource for a permission in accordance with the present invention.

FIG. 1F provides an example of a web page that presents information that is the subject of a resource for a permission in accordance with the present invention.

FIG. 2A illustrates a message sequence chart of a preferred embodiment of the present invention.

FIG. 2B illustrates a system of one embodiment of the present invention.

FIG. 3A illustrates a message sequence chart of a preferred embodiment of the present invention.

FIG. 3B illustrates a system of one embodiment of the present invention.

FIG. 3C illustrates exemplary data structures for a permission and two permission links.

FIG. 4A illustrates a message sequence chart of a preferred embodiment of the present invention.

FIG. 4B illustrates a system of one embodiment of the present invention.

FIG. 4C illustrates an exemplary data structure for a multi-subject permission.

FIG. 5 is a flow diagram illustrating a method of providing secure access to a service on a web server in accordance with a preferred embodiment of the present invention.

FIG. 6 is a flow diagram illustrating a method of providing secure access to a service on a web server in accordance with a preferred embodiment of the present invention.

FIG. 7 is a flow diagram illustrating a method of providing secure access to a service on a web server in accordance with a preferred embodiment of the present invention.

FIG. 8 is a flow diagram illustrating a method of providing secure access to a service on a web server in accordance with a preferred embodiment of the present invention.

FIG. 9 is a flow diagram illustrating a method of providing secure access to a service on a web server in accordance with a preferred embodiment of the present invention.

FIG. 10 is a flow diagram illustrating a method of providing secure access to a service on a web server to each of a plurality of recipients of an electronic message in accordance with a preferred embodiment of the present invention.

### DETAILED DESCRIPTION

Reference will now be made in detail to the preferred embodiments of the present invention, examples of which are illustrated in the accompanying drawings. It is to be understood that the figures and descriptions of the present invention included herein illustrate and describe elements that are of particular relevance to the present invention, while eliminating, for purposes of clarity, other elements. Those of ordinary skill in the art will recognize that other elements may be desirable and/or required in order to implement the present invention. However, because such elements are well known in the art, and because they do not facilitate a better understanding of the present invention, a discussion of such elements is not provided herein.

The invention described herein relates to creation and manipulation of permissions, signed with a digital signature. There are a variety of different ways for creating such permissions. For example, permissions may have a form similar to ones defined in IETF RFC 2693, Simple Public Key Infrastructure Certificate Theory. The preferred embodiments disclosed herein describe permissions that are created through use of public/private key encryption techniques. However, other methods of creating a digital signature are known to those skilled in the art and may be used in connection with the present invention.

In one aspect of the invention, a user may delegate a permission to a server and may allow the server to delegate this permission to parties that are able to access it. This allows the first party to effectively delegate access to a resource to a collection of parties as determined by the permission server. This can be done even if the permission was granted to the first user via a chain of delegated permissions for a resource controlled by a third party. The resulting system enables authenticated users to “surf” through the system and automatically gain credentials that testify to their acquired right to access resources on other servers.

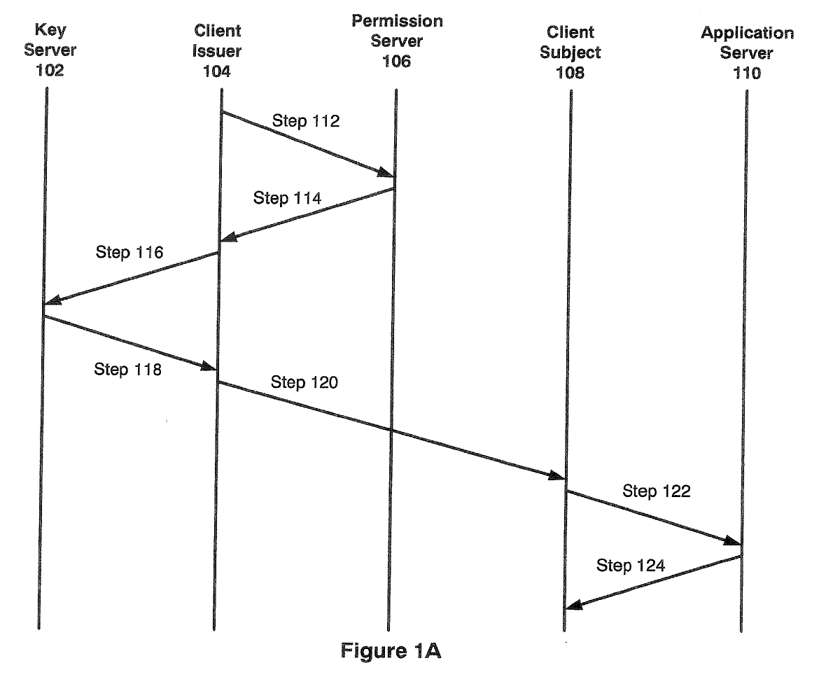

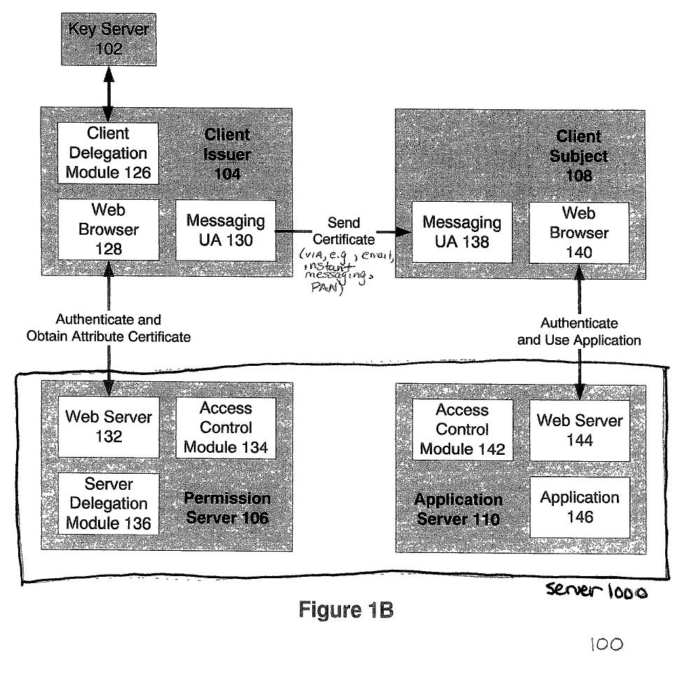

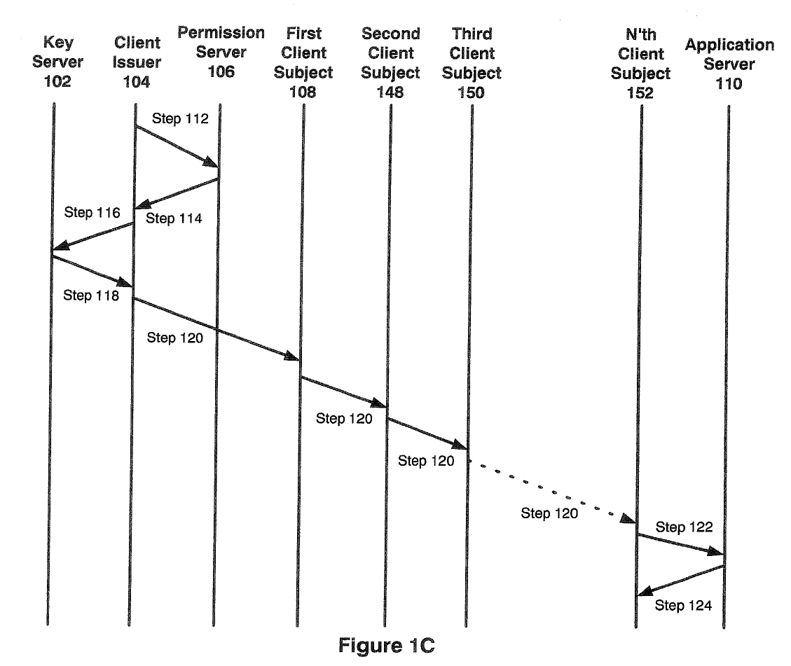

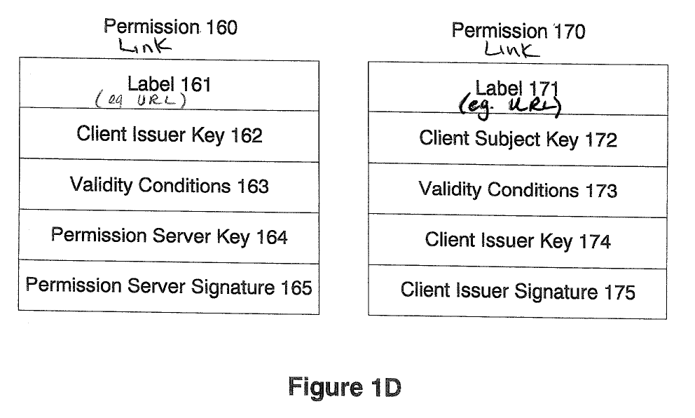

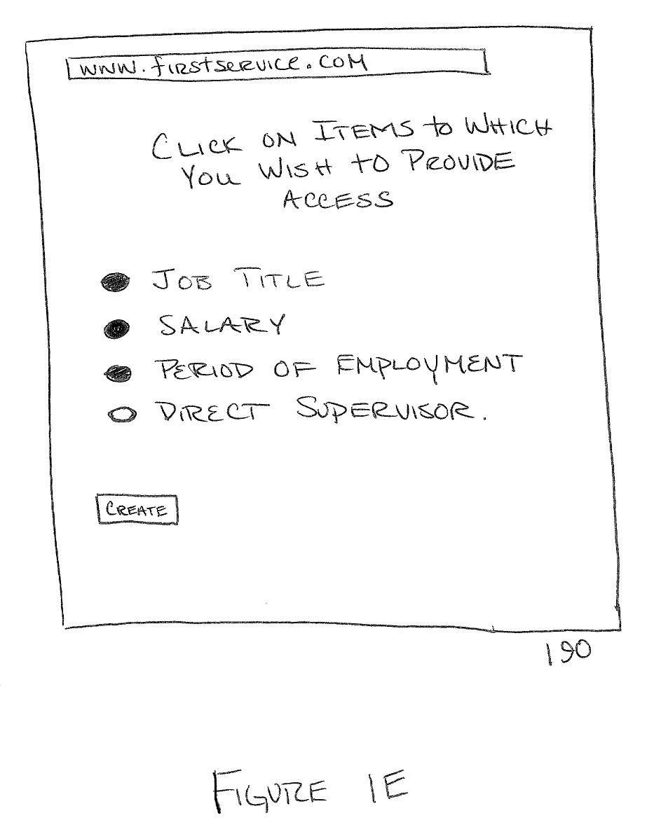

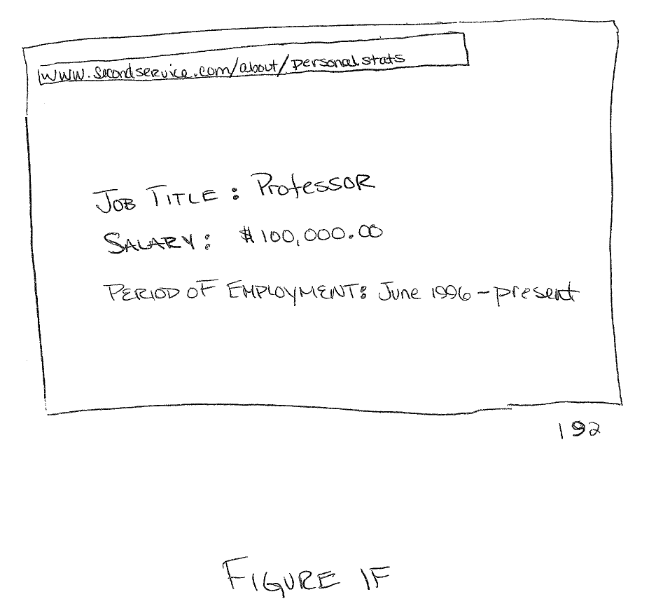

FIG. 1A depicts a message sequence chart illustrating a preferred embodiment of a method of providing secure access to a service maintained on a server in accordance with the present invention. The term service referred to herein relates to accessing or delivery of content, referring broadly to any object, data, documents, files, directories, text, software, computer applications or other information. In step 112, a first user employs client issuer 104 to access permission server 106. Permission server 106 enables the first user to determine a label that relates to the service. For example, the label could comprise a query against a database that requests the desired information. The label may be a URL that identifies the location of the service on the web or may include such a URL. Alternatively, the label does not include a URL, but instead allows the URL indicating the location of the service to be determined from another source. In this case, the label represents a status from which benefits derive (i.e. the ability to access the service) rather than identifying the service particularly. The label may be associated with the URL using many different algorithms. By way of example, the label may include a URL within the domain of the URL that identifies the location of the desired service. In another example, the label may include a public key that is mentioned in the web site supporting the desired service.

A first permission link, including the label, is created at permission server 106 and, in step 114, provided to the first user at client issuer 104. In step 116, the first user requests from key server 102 the public key of a second user. In step 118, key server 102 provides the key to the first user at client issuer 104. The first user creates a second permission link, including the label, at client issuer 104. In step 120, the first user sends a permission (that includes the first permission link and the second permission link) to the second user at client subject 108. In step 122, the second user authenticates to application server 110 using his private key to identify himself and supplies the permission seeking authorization to access the service. Application server 110 verifies the information contained in the permission. In step 124, application server 110 provides the second user with access to the service based on an analysis of the information in the permission.

FIG. 1B depicts a preferred embodiment of a system 100 for carrying out the methods described with reference to FIG. 1A. A first user employs the web browser 128 on client issuer 104 (which may be a personal computer) to access permission server 106 via web server 132. Using server delegation module 136 on permission server 106, the first user determines a label that relates to an application 146 on application server 110, as discussed with reference to FIG. 1A.

A first permission link is created by server delegation module 136 at permission server 106. The first permission link includes a digital signature created by permission server 106 based on a public key of the first user and the label. The identity of the first user is verified using access control module 134. Permission server 106 then provides the first permission link to the first user at client issuer 104. The first user then employs client delegation module 126 of client issuer 104 to request from key server 102 (which maintains a registry of public keys) the public key of a second user. Key server 102 returns the key to client delegation module 126. Using client delegation module 126, the first user creates a second permission link that includes the label, the public key of the second user and a digital signature of the first user. Using messaging user agent 130 of client issuer 104, the first user sends a permission (which includes the first permission link and the second permission link) to the second user using messaging user agent 138 of client subject 108. The permission may be provided by the first user to the second user by employing a messaging system, such as electronic mail or instant messaging, or by using a personal area network.

The second user, using web browser 140 of client subject 108, authenticates to application server 110 through web server 144 using its private key and seeks authorization to access the service by supplying the permission. Access control module 142 of application server 110 verifies the digital signatures in the permission and confirms that the public key of the second user as provided in the second permission link corresponds to the private key of the second user. Access control module 142 also confirms that validity conditions included in the permission are met (such as whether the permission validity time period has expired). Upon verification, application server 110 allows the second user access to the application 146.

In some embodiments, the various components and functionality of permission server 106 and application server 110 may be located on one server, for example, server 1000 shown in FIG. 1B. In other embodiments, the first and second users may be the same person (e.g., one person may want to delegate a permission from one client to another). For instance, a user may want to create and delegate to himself a permission that provides him with easy access to application 146 at a future time. For example, the user may want to create a permission for use while the user is on the road.

In an alternate preferred embodiment, in step 114 of FIG. 1A, the permission server 106 does not create a permission for the first user and, instead, provides to the user only the label determined by the first user. With reference to FIG. 1B, the first user employs client delegation module 126 of client issuer 104 to request from key server 102 the public key of a second user, and key server 102 provides the key to client delegation module 126 (steps 116 and 118 of FIG. 1A). Using client delegation module 126, the first user creates a permission that includes the label, the public key of a second user and a digital signature of the first user. The first user then sends the permission to the second user (step 120 of FIG. 1A). The second user, using web browser 140 of client subject 108, authenticates to application server 110 using web server 144 and supplies the permission (step 122 of FIG. 1A). Access control module 142 of application server 110 verifies the digital signature in the permission. Application server 110 allows the second user access the application 146 (step 124 of FIG. 1A) based on an analysis of the permission.

In these embodiments, application server 110 may verify that the first user has the right to delegate access to the application using, for example, access control module 142. For example, access control module 142 may maintain an access control list (“ACL”) that would allow it to confirm this fact.

Still another preferred embodiment of a method of providing secure access to a service on a server allows for numerous chained delegations, as illustrated in the message sequence chart of FIG. 1C. In this embodiment, steps 112, 114, 116, 118 and 120 are the same as those described with reference to FIG. 1A. However, in this embodiment, the delegation described in step 120 is repeated one or more times. Thus, the second user may create a subsequent permission link using the first client subject 108. The second user then sends a permission (comprising the first permission link, the second permission link and the subsequent permission link) to a subsequent user at second client subject 148 in step 120.

The subsequent user may then create a second subsequent permission link and delegate a permission (comprising the first permission link, the second permission link, the subsequent permission link and the second subsequent permission link) using second client subject 148 to a second subsequent user at third client subject 150 in step 120. This series of delegations could continue any number of times. Then, in step 122, the Nth subsequent user employs the Nth client subject 152 and authenticates to application server 110 using the Nth permission. Application server 110 verifies each digital signature in each permission link in the Nth permission and confirms that the public keys of each user as provided in each permission link corresponds to the private keys of such user. In step 124, application server 110 provides the Nth subsequent user access to the service.

As mentioned above, the service to which a user ultimately is provided access may not be one located at a particular URL determined by the first user. Instead, the service to which the second or subsequent user is provided access may be one derived from the URL. For example, the permission provided to the second or subsequent user may include the authority to access a particular domain. Authority to access other web pages within the domain are implied from authority to access the domain. In a particular example, the permission may include authority to access the home page of a particular web site. However, when the second or subsequent user exercises the authority delegated to him, such user is given access to an internal page of web site, rather than or in addition to the home page. Authority to access to the internal page is implied by the user's authority to access the home page. Thus, the resource to which the second user gained access was not specifically named by the URL determined by the user, but authorization to access to the resource was implied by authorization to access to the URL.

FIG. 1D illustrates exemplary data structures of permissions that may be used in connection with the present invention. These permissions are constructed using public/private key encryption techniques. Permission link 160 of FIG. 1D may be created by permission server 106 and returned to client issuer 104 in step 114 of FIG. 1A. Permission link 160 includes the label 161 associated with the service (e.g., application 146 of FIG. 1B), the public key 162 of client issuer 104, and the private key 164 of permission server 106. Permission link 160 may also include validity conditions 163, such as the validity time period for permission link 160 and whether the permission includes authority to further delegate the label. Each of these items is signed with digital signature 165 of the permission server 106, which cryptographically binds the identity of the permission server 106 to each of the items.

With reference to FIG. 1A, upon obtaining the public key of the client subject 108 from key server 102, client issuer 104 may create permission link 170 (shown in FIG. 1D). Permission link 170 includes label 171, the public key 172 of client subject 108, and the private key 174 of client issuer 104. Permission link 170 may also include validity conditions 173, such as the validity time period for permission link 170 and/or other information (e.g., whether the permission included permission to further delegate). Each of these items is signed with digital signature 175 of client issuer 104, which cryptographically binds the identity of the client issuer to each of these items. Permission link 160 and permission link 170 are then chained to form a permission, which is, for example, delegated in step 120 of FIG. 1A to client subject 108. In alternative embodiments of the present invention, the permissions links are nested rather than chained. In the case of nested permissions, the label would not be repeated, assuming it remains unchanged. Also, in the case of nested permissions, the signature must include some material from the previous links.

The permissions used in connection with the present invention may be validated in accordance with a number of techniques (depending primarily on the technique used to create the digital signature) that are known to those skilled in the art. One example of rules for verification is described in IETF RFC 2693 Simple Public Key Infrastructure Certificate Theory. In general, such validation typically includes verifying the signatures in each permission link (e.g., digital signature 165 and digital signature 175) as well as performing chain checking to ensure, for example, that the label included in each permission link represents the same or less authority presented in each of the preceding permissions.

An illustrative example of the methods and systems described with reference to FIGS. 1A and 1B is shown with reference to FIGS. 1E and F. In this example, a user wishes to provide information about the user's employment to a company from which the user seeks to obtain a mortgage. The user employs screen 190, shown in FIG. 1E, to select the items to which he wishes to provide the mortgage company access. Here, the user determines that he wishes to provide the mortgage company his job title, salary and period of employment and indicates the same on screen 190. The user then clicks on the “create” button. In doing so, in this example, the user is creating a label that comprises a query against a database to be submitted ultimately by the mortgage company to learn the information. The label is included in a first permission link, as described previously herein. Upon creating the permission link, it is returned, for example, as an attachment in an e-mail to the user or provided within the user's browser (which can then be saved, opened or otherwise manipulated). The user may then create a second permission link and send it, along with the first permission link, to the mortgage company. This may be done, for example, by way of a messaging system such as electronic mail.

The mortgage company may then use the permission (which includes the first permission link and the second permission link) to attempt to gain access via the web to the information. Upon verifying the information in the permission, the mortgage company is presented with screen 192 of FIG. 1F, which displays the information identified by the first user's query. In the preferred embodiment of the present invention, the information displayed on screen 192 is not merely a static list information but, instead, is representative of an ongoing service that obtains the information identified by the first user's query each time it is requested. Thus, the information displayed is dynamic and changes in accordance with any changes made in the database that stores the information. For example, if the user's job title or salary changes, and this change is reflected in the database against which the query is run, the change will be reflected in screen 192 upon the mortgage company accessing it. This feature may be particularly valuable in other contexts in which the same resource is accessed frequently and the information to be obtained from that resource is variable.

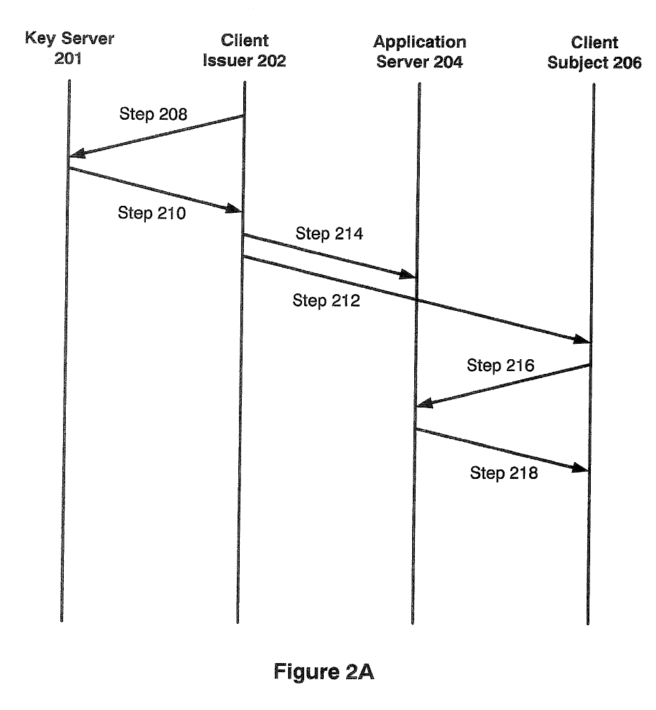

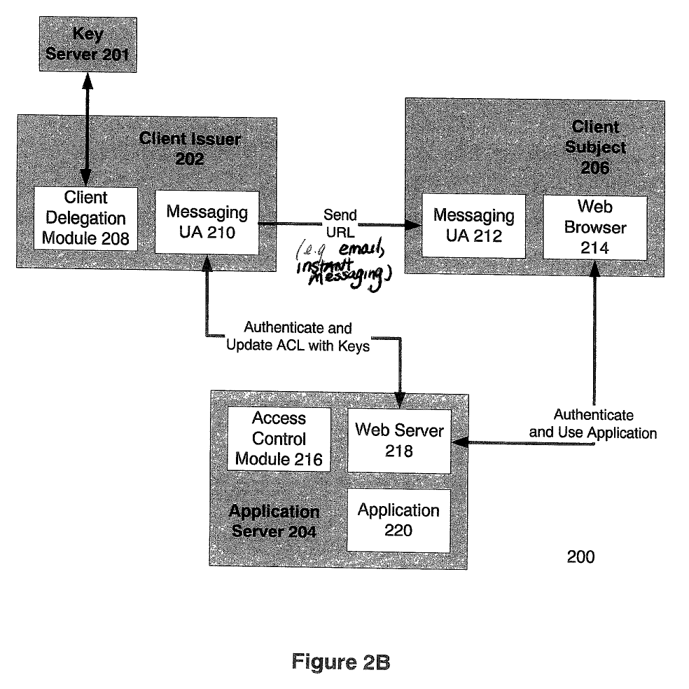

FIG. 2A depicts a message sequence chart illustrating another preferred embodiment of a method of providing secure access to a service maintained on a web server in accordance with the present invention. In step 208, a first user employs the client issuer 202 to request from key server 201 the public key of the individual to whom the first user wishes to delegate permission to access the service. In step 210, the key is returned to client issuer 202. In step 212, the first user employs client issuer 202 to inform the second user, by sending an electronic message to client subject 206, that the second user must contact application server 204 to obtain access to the service. Upon the first user undertaking step 212, in step 214, client issuer 202 automatically updates application server 204 with the key information (e.g., the public key or information based on the public key) obtained in step 210 along with the label. In step 216, the second user, employing client subject 206, authenticates to application server 204 and, in step 218, application server 204 provides the second user access to the service.

FIG. 2B depicts a preferred embodiment of a system 200 for carrying out the methods described with reference to FIG. 2A. The first user employs client delegation module 208 of client issuer 202 to obtain from key server 201 the public key of the individual to whom the first user wishes to delegate permission to access the service. The first user then employs messaging user agent 210 of client issuer 202 to inform the second user at client subject 206, through messaging user agent 212, of the URL corresponding to the location of application server 204 so that the second user may obtain access to the service (i.e., application 220). Upon the first user sending this message to the second user, messaging user agent 210 of client issuer 202 automatically contacts application server 204 through web server 218. Upon contacting application server 204, messaging user agent 210 updates access control module 216 with the key information of the second user obtained from key server 201 along with the label. The second user employs web browser 214 of client subject 206 to authenticate to application server 204 by providing its private key. Application server 204 confirms through access control module 216 that the private key of the second user corresponds to public key of the second user. If so, the second user is provided access to application 220.

The methods and systems described with reference to FIGS. 2A and 2B are useful in the same manner as those described with reference to FIGS. 1A and 1B. For example, an individual seeking a mortgage may wish to provide a mortgage company with information regarding the individual's employment in connection with the mortgage approval process. The first user may determine a URL corresponding to the desired information and send the mortgage company an electronic message (for example, an electronic mail message) that contains the URL. Upon the sending of the message, an ACL is updated with the public key information of the mortgage company. The mortgage company may then seek access to the information by supplying the URL and authenticating to the server using the mortgage company's private key.

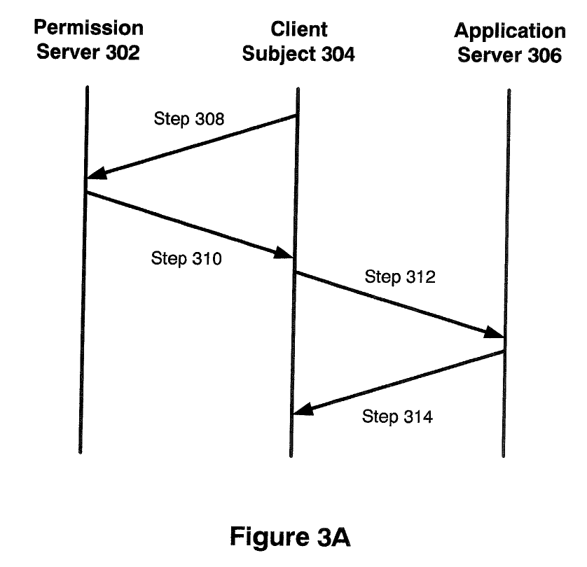

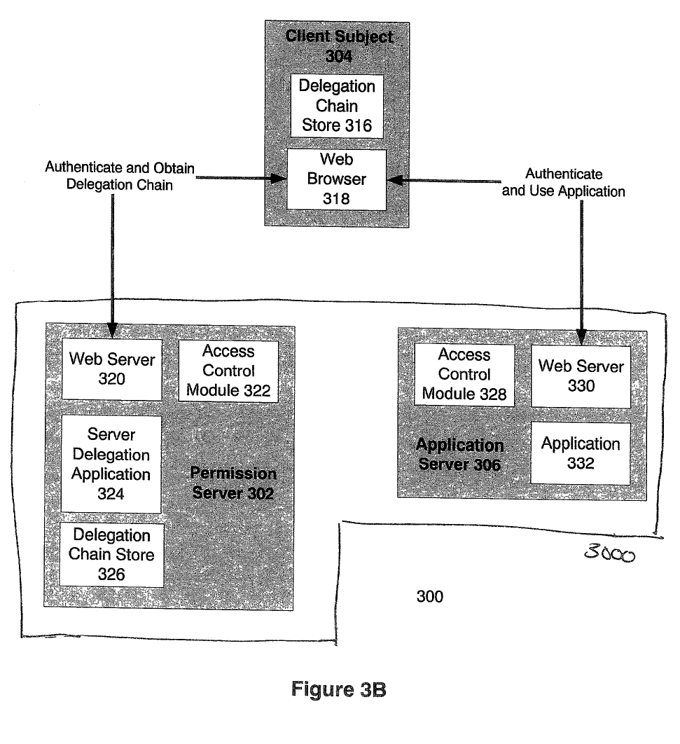

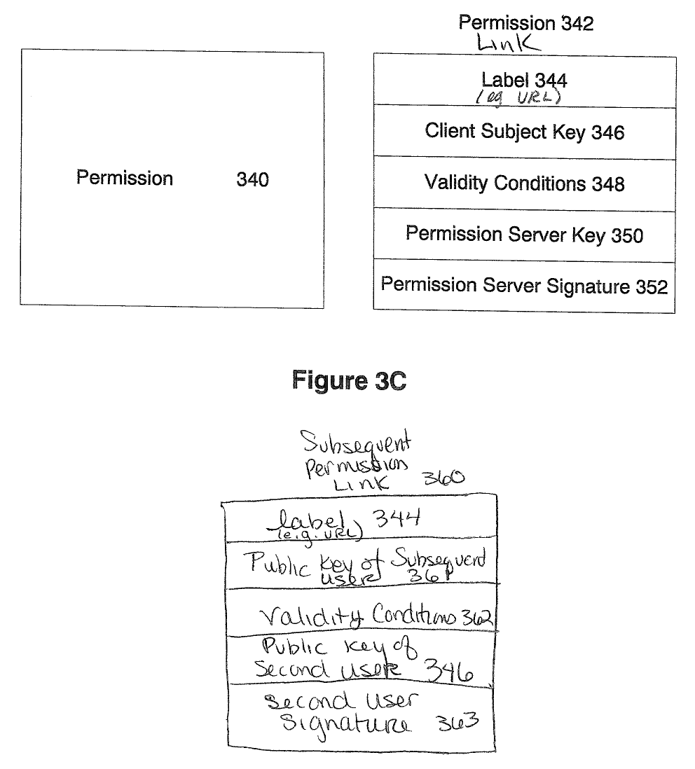

FIG. 3A is a message sequence chart that illustrates a method of providing secure access to a service located on a server in accordance with another preferred embodiment of the present invention. A first permission link is created, in one example, by the first user, and maintained on permission server 302. The first permission link provides permission server 302 with the authority to grant permission to access the service to individuals who are identified (e.g., by the first user), who request access to the service and who are properly authenticated and authorized. The individuals are identified and their public keys are stored in an ACL.

In step 308, a second user employs client subject 304 to authenticate to permission server 302, seeking permission to access the service. Assuming the second user is one identified by the first user to obtain permission to access the service, the second user obtains, in step 310, a second permission link created by permission server 302. In step 312, the second user employs client subject 304 to authenticate to application server 306 and supplies a permission (comprising the first permission link and the second permission link). In step 314, application server 306 verifies the permission and, assuming a positive result, provides the second user with access to the service. In some embodiments, after step 310, the second user delegates the permission to a subsequent user (in addition to or in lieu of the second user performing step 312). The subsequent user may then, in step 312, authenticate to application server 306 using client subject 304 and supply his permission. The subsequent user's permission is verified in step 314 and, assuming a positive result, the subsequent user is provided access to the service.

A preferred embodiment of a system 300 that may be used to carry out the methods described with reference to FIG. 3A is illustrated in FIG. 3B. A first user creates and maintains in delegation chain store 326 of permission server 302 a permission link (for example, permission 340 of FIG. 3C). In the preferred embodiment, the permission link includes a label relating to the service 332, a digital signature of the first user and a public key of permission server 302. The first user also stores in access control module 322 information regarding the identity (e.g., public key information) of the individual(s) to whom the permission may be delegated upon request.

A second user employs web browser 318 of client subject 304 to access permission server 302 through web server 320 and authenticates to permission server 302. Upon verifying with access control module 322 that the second user is one of the individuals to whom the permission may be delegated, server delegation application 324 delegates permission to access the service to the second user. Referring again to FIG. 3C, the second user is delegated a permission that includes permission 340, described previously, and permission link 342. Permission link 342 includes, in one embodiment, the label 344, the public key 346 of the second user, validity conditions 348, the public key 350 of permission server 302, and is signed with the digital signature 352 of permission server 302.

Using web browser 318 of client subject 304, the second user contacts application server 306 through web server 330 and authenticates to application server 306 using the private key of the second user and supplies the permission. Using access control module 328, application server 306 verifies the information in the permission (i.e., the signatures, validity conditions, etc.). Upon successful verification, application server 306 provides the second user access to application 332.

As stated with reference to FIG. 3A, the second user may also delegate a permission to access the service to a subsequent user. This delegation may be accomplished in a number of different ways including email, PAN or the method described with reference to FIGS. 3A and 3B. The permission delegated to the subsequent user may be described with reference to FIG. 3C. The subsequent permission includes permission 340, permission link 342 and subsequent permission link 360, (which includes the label 344, the public key 361 of the subsequent user, validity conditions 362, the public key 346 of the second user and digital signature 363 of the second user). Further delegations can be made by any subsequent user.

As with the systems and methods described in FIGS. 1A and 1B, the first and second user of the systems and methods described with reference to FIGS. 3A and 3B may be the same person. Similarly, the components of permission server 302 and application server 306 may be maintained on a single server 3000, shown in FIG. 3B.

The methods and systems described with reference to FIGS. 3A and 3B are useful in many contexts. For example, the first user may know of many individuals who may potentially want permission from the first user to access a particular service. The first user is willing to grant such permissions, but does not know which of the many individuals will actually seek to access the service. The user may employ the methods and systems illustrated in FIGS. 3A and 3B to store a permission on permission server 302 to be delegated by permission server 302 only to particular individuals (within the larger class of individuals to whom the first user is willing to delegate permission) who request it.

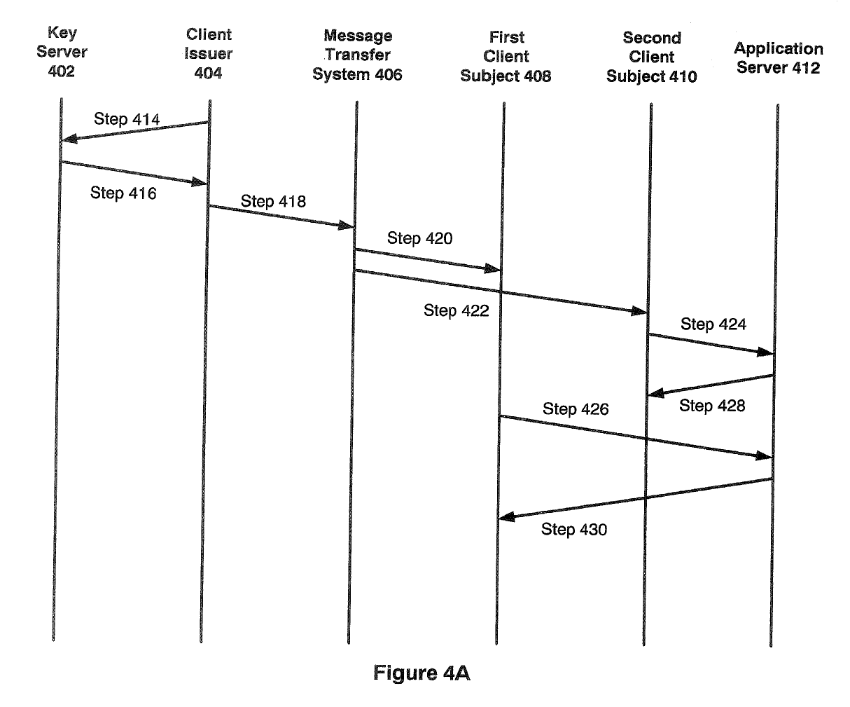

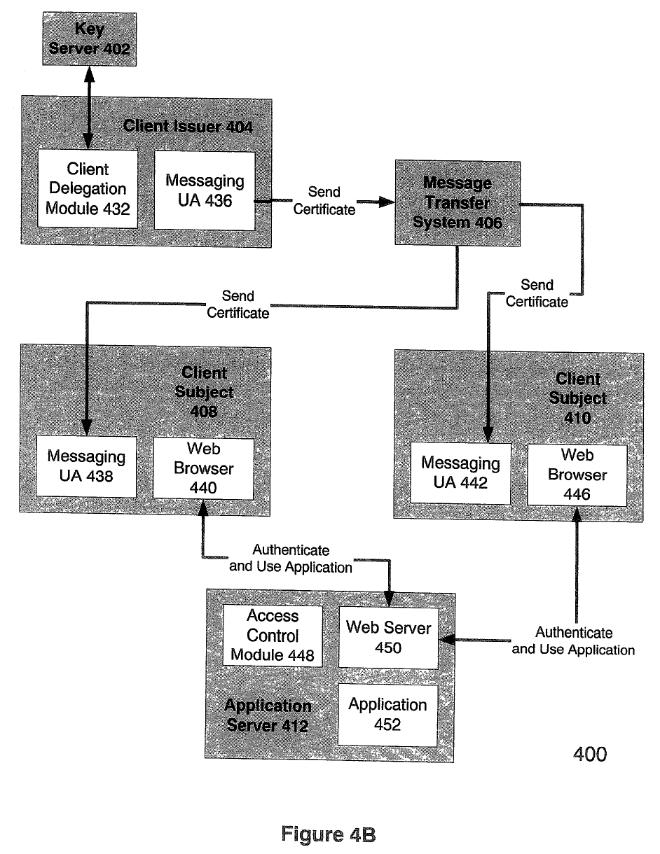

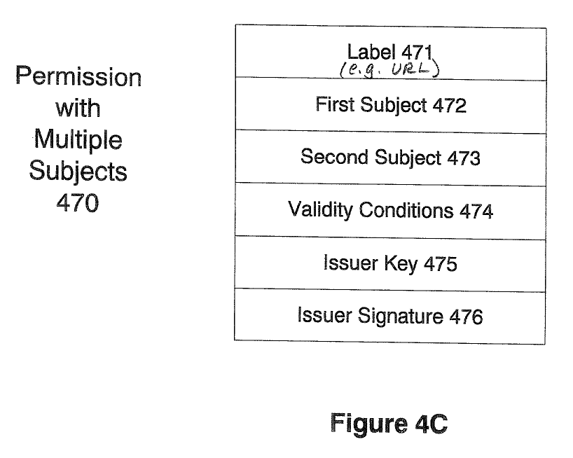

The present invention also provides a method for distributing a permission to multiple recipients. FIG. 4A is a message sequence chart that illustrates delegation of permission to multiple recipients using electronic messaging systems. In step 414, a first user employs client issuer 404 to contact key server 402 to request key information (i.e., the public keys) for the multiple individuals to whom the first user wants to delegate a permission. In step 416, the key information is returned. The client issuer 404 creates a single permission addressed to multiple recipients (including their keys) and sends it to message transfer system 406. Message transfer system 406 makes copies of the permission and sends a copy to each address. In this example, message transfer system 406 sends the permission to first client subject 408. Message transfer system 406 also sends the permission to second client subject 410. In other examples involving more than two recipients, the permission may be sent to more than two client subjects within the scope of the present invention. Second client subject 410 authenticates to application server 412 in step 424 by presenting its private key and seeks to gain authorization by supplying the permission. First client subject 408 authenticates to application server 412 in step 426 by presenting its private key and seeks to gain authorization by supplying the permission. Upon successful authentication and authorization by the second client subject 410, in step 428, second client subject 410 obtains access to the service. In step 430, upon successful authentication and authorization of the first client subject 408, the first client subject 408 obtains access to the service.

FIG. 4B illustrates a preferred embodiment of a system for carrying out the methods described with reference to FIG. 4A. Using client delegation module 432, client issuer 404 contacts key server 402 to obtain the public key of each individual to whom the first user wants to delegate permission to access application 452. Client issuer 404 then creates a multi-subject permission using client delegation module 432.

This multi-subject permission is described with reference to FIG. 4C, by way of example. The label 471 is included in permission 470, as is the public key of the first subject 472, the public key of the second subject 473, any validity conditions 474, and the public key of the issuer 475. Additional public keys may be included if the permission chain is intended for more than two subjects. Permission 470 is signed with the digital signature of the issuer 476, as illustrated in FIG. 1D. Thus, the identities of the individuals that are to receive the electronic message, including their private keys, are automatically included in the permission and signed by the first user.

Returning again to FIG. 4B, the permission (such as permission 470 of FIG. 4C) provides that each of the individuals whose key information is included in the multi-subject permission should be provided access to application 452. Using messaging user agent 436 of client issuer 404, the first user sends the multi-subject permission in a single electronic mail message, addressed to each of the recipients, using message transfer system 406. Message transfer system 406 makes a copy of the multi-subject permission and sends it to each user that is to receive the permission (i.e., client subject 408 and client subject 410 through messaging user agent 438 and messaging user agent 442, respectively, in this example).

After receiving the permission from message transfer system 406, using web browser 446, second client subject 410 authenticates to application server 412 through web server 450. Using web browser 440, first client subject 408 authenticates to application server 412 through web server 450. Access control module 448 of application server 412 verifies the information in the permission provided by the first client subject 408 and, upon verification, provides access to application 452. Similarly, but separately, access control module 448 of application server 412 verifies the information in the permission provided by the second client subject 410 and, upon verification, provides access to application 452.

As discussed elsewhere herein, the label included in the permission may either be a URL or may include a URL. In these embodiments, it is clear that the permission to be presented by the user when attempting to gain access to a particular URL is the permission that contains the URL. In other embodiments, any permissions containing a URL that is within the domain of the URL approached by the user may be identified and presented. However, in some cases, requiring that the URL constitute part of the permission, or even requiring that the permission contain a URL that is within the domain of the URL to which access is desired, may be too limiting because such a permission will only be useful for obtaining access to a service located at the specific URL named or one within its domain. Thus, it may be desirable to configure the label such that it does not include any URL, but instead allows the URL indicating the location of the desired service to be determined from another source.

However, when the user approaches a particular URL, a determination must still be made as to which permission to present. In cases in which the URL is not part of label (and, thus, not part of the permission), this may be accomplished in a number of different ways. In one solution, upon the user approaching the URL, the server hosting the URL may make a request that the user upload a particular permission. Yet another solution involves use of MIME types as described in more detail in Maywah, A. J., “An Implementation of a Secure Web Client Using SPKI/SDSI Certificates”, Massachusetts Institute of Technology, pp. 64-68, May 2000, which is hereby incorporated by reference.

In still another solution, the URL to which the user seeks access may include a piece of information that constitutes an invitation to the user to supply a particular permission, which is done automatically upon the user attempting to access the URL. This approach avoids the step of requiring the user to upload the permission required. Given that the user may not even know the invitation in the URL exists, in some embodiments, the user may be warned in advance of the invitation. This will enable the user to make an informed decision in advance as to whether to proceed to attempt to gain access to the service at the URL.

In still other solutions, the invitation to supply a particular permission may be included within a web page associated with the URL to which the user seeks to gain access. For example, the invitation may be included within an HTML tag of the web page. The invitation may take several forms. For example, in the preferred embodiment, the invitation is a specific field within the HTML tag. Thus, when the user retrieves the web page associated with the URL, the tag that includes the invitation is retrieved along with the web page. This tag will allow the required credential information to be provided.

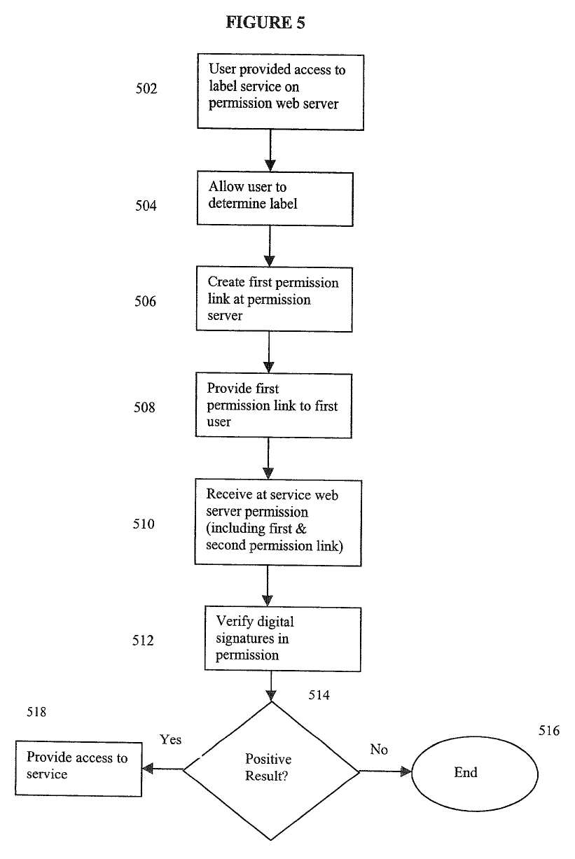

With reference to FIG. 5 through FIG. 10, several methods of providing secure access to a service on a web server in accordance with preferred embodiments of the present invention are illustrated. With reference to FIG. 5, in step 502, a first user is provided access to a label service on a permission web server. In step 504, the first user is allowed to determine, using the label service, a label related to the service. In step 506, a first permission link is created at the permission web server. The first permission link includes the label and a digital signature of the permission web server. The first permission link is provided to the first user in step 508. In step 510, a permission, including the first permission link and a second permission link, is received at the service web server from a second user. The second permission link is created by the first user and includes a digital signature of the first user. In step 512, the digital signatures in the permission are verified. In step 514, it is determined whether an analysis of the permission produces a positive result. If not, in step 516 the process ends. If the analysis produces a positive result, in step 518, the second user is provided access to the service.

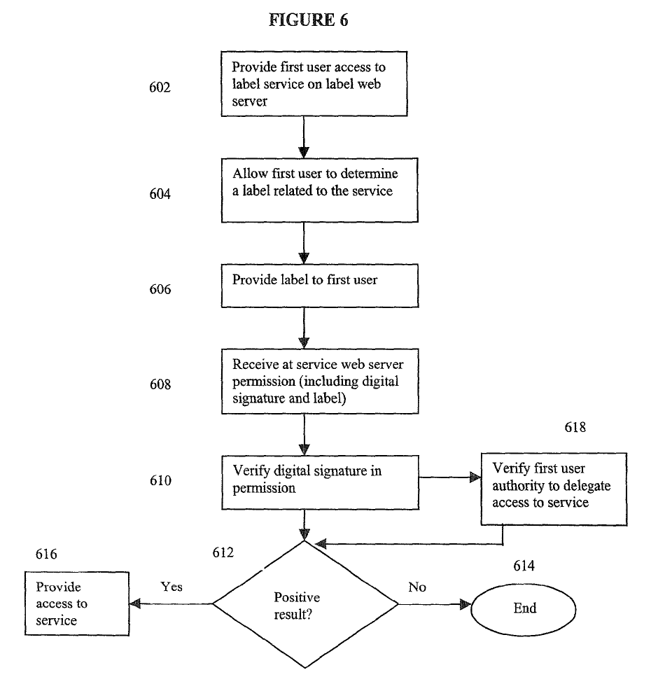

With reference to FIG. 6, in step 602, a first user is provided access to a label service on a label server. In step 604, the first user is allowed to determine, using the label service, a label related to the service. In step 606, the label is provided to the user. In step 608, a permission is received at the service web server from a second user. The permission is created by the first user and includes a digital signature of the first user and the label. In step 610, the digital signature in the permission is verified. In step 612, it is determined whether an analysis of the permission produces a positive result. If not, in step 614, the method ends. If the analysis produces a positive result, in step 616, the second user is provided access to the service. In a preferred embodiment, in step 618, it is verified that the first user had the authority to delegate access to the service.

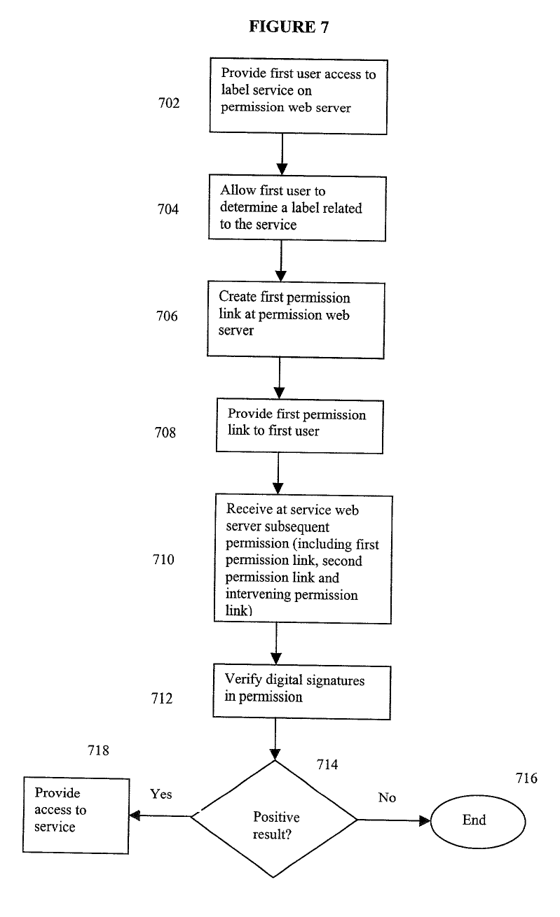

With reference to FIG. 7, in step 702, a first user is provided access to a label service on a permission web server. In step 704, the first user is allowed to determine, using the label service, a label related to the service. In step 706, a first permission link is created at the permission web server. The first permission link includes the label and a digital signature of the permission web server. In step 708, the first user is provided the first permission link. In step 710, a subsequent permission is received at the service web server from a subsequent user. The subsequent permission includes the first permission link, a second permission link (which includes a digital signature of the first user), and at least one intervening permission link (which includes a digital signature of at least one intervening user). In step 712, the digital signature of the permission web server, the first user, and each intervening user in the subsequent permission is verified. In step 714, it is determined whether an analysis of the subsequent permission produces a positive result. If not, in step 716, the process ends. If so, in step 718, the subsequent user is provided access to the service.

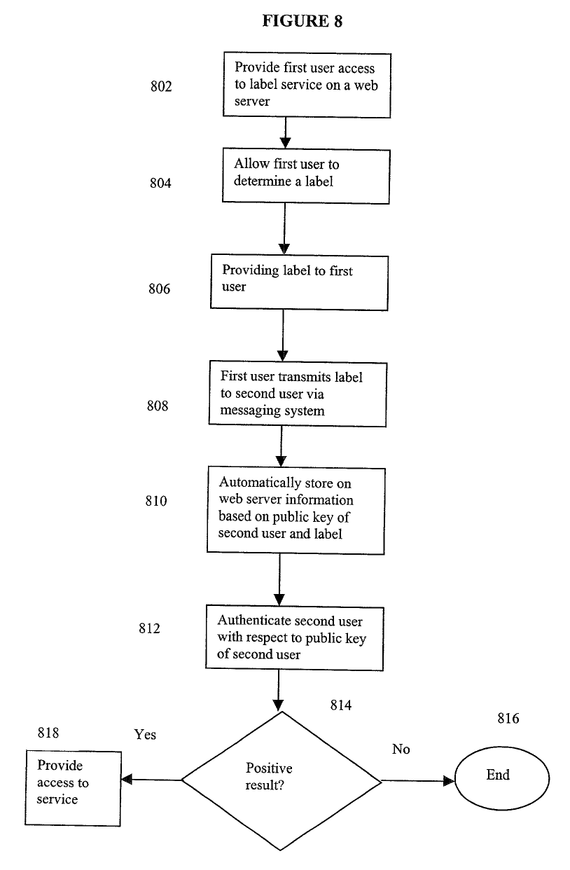

With reference to FIG. 8, in step 802, a first user is provided access to a label service on a web server. In step 804, the first user is allowed to determine, using the label service, a label relating to the service on the web server. In step 806, the label is provided to the first user. In step 808, the first user transmits the label to a second user via a messaging system, and in step 810, information based on a public key of the second user and the label is automatically stored on the web server In step 812, the second user is authenticated with respect to his public key. In step 814, it is determined whether the authentication process produces a positive result. If not, in step 816, the process ends. If so, in step 818, the second user is provided access to the service.

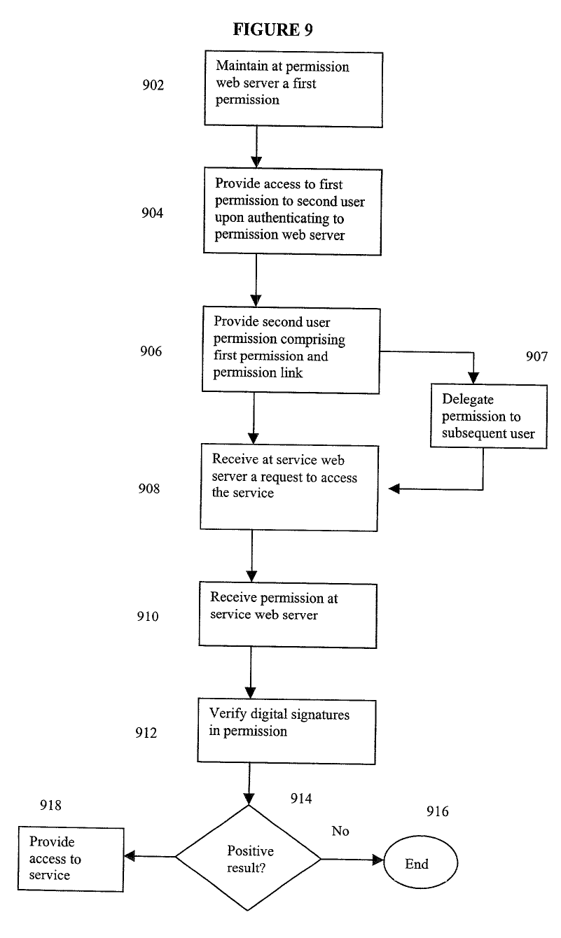

With reference to FIG. 9, in step 902, a first permission is maintained at a permission web server. The first permission includes a label relating to the service and a digital signature of a first user. In step 904, a second user is provided access to the first permission upon the second user authenticating to the permission web server. In step 906, the second user is provided a permission. The permission includes the first permission and a permission link (including the label and a digital signature of the permission web server). In some embodiments, in step 907 the second user delegates the permission to a subsequent user. In step 908, a request to access the service is received at the web server from the second (or subsequent ) user. In step 910, the permission (or subsequent permission) is received at the service web server from the second (or subsequent) user. In step 912, the digital signatures in the permission (or subsequent permission) are verified. In step 914, it is determined if the verification produces a positive result. If not, the process ends in step 916. If so, in step 918, the second (or subsequent) use is provided access to the service.

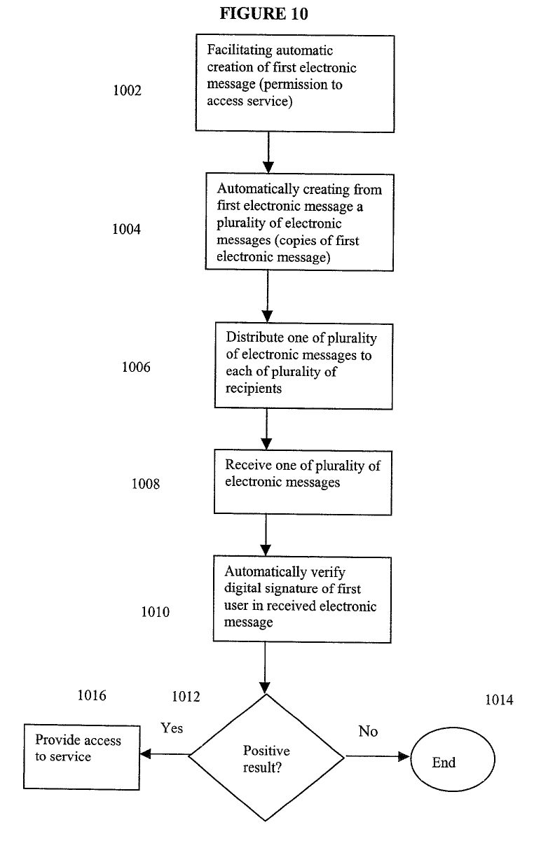

With reference to FIG. 10, in step 1002, automatic creation of a first electronic message directed to a plurality of recipients by a first user is facilitated. The first electronic message includes a permission to access the service based on a public key of each recipient and is signed with a digital signature of the first user. In step 1004, a plurality of electronic messages (each including a copy of the first electronic message) is automatically created from the first electronic message. In step 1006, one of the plurality of electronic messages is distributed to each of the plurality of recipients. In step 1008, one of the plurality of electronic messages is received from at least one of the plurality of recipients. In step 1010, the digital signature of the first user in the received electronic message is automatically verified by the web server. In step 1012, it is determined whether the verification process produces a positive result. If not, in step 1014, the process ends. If so, in step 1016, access to the service is provided.

The foregoing description of the preferred embodiments is provided to enable those skilled in the art to make and use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

What is claimed is:

1. A method of providing secure access to a service on a service web server comprising:
(a) maintaining at a permission web server a first permission, wherein the first permission comprises a label related to the service and a digital signature of a first user;
(b) providing access to the first permission to a second user upon said second user authenticating to said permission web server;
(c) providing the second user a permission comprising the first permission and a permission link comprising the label and a digital signature of the permission web server;
(d) receiving at the service web server from said second user a request to access the service;
(e) receiving the permission from the second user at the service web server;
(f) verifying the digital signature of the permission web server and the digital signature of the first user in the permission; and
(g) providing the second user access to the service if step (f) produces a positive result.

2. The method of claim 1 wherein the first and second user are the same.

3. The method of claim 1 wherein the label comprises a URL for identifying the service.

4. A system for providing secure access to a service on a service web server comprising:
a permission web server that maintains a first permission, wherein the first permission comprises a label related to the service and a digital signature of a first user; that provides a second user access to the first permission upon the second user authenticating to the permission web server; and that provides the second user a permission comprising the first permission and a permission link comprising the label and a digital signature of the permission web server; and
the service web server that receives from the second user a request to access the service and the permission; that verifies the digital signature of the permission web server and the digital signature of the first user in the permission; and that provides the second user access to the service if the verification produces a positive result.

5. A method of providing secure access to a service on a service web server comprising:
(a) maintaining at a permission web server a first permission, wherein the first permission comprises a label related to the service and a digital signature of a first user;
(b) providing access to the first permission to a second user upon said second user authenticating to said permission web server;
(c) providing the second user a permission comprising the first permission and a permission link comprising the label and a digital signature of the permission web server;
(d) receiving at the service web server from a subsequent user a request to access the service, the subsequent user having been delegated a subsequent permission comprising the permission;
(e) receiving the subsequent permission from the subsequent user at the service web server;
(f) verifying at least the digital signature of the permission web server and the digital signature of the first user in the permission; and
(g) providing the subsequent user access to the service if step (f) produces a positive result.

6. The method of claim 5 wherein the subsequent permission is delegated to the subsequent user via electronic mail.

7. The method of claim 5 wherein the subsequent permission is delegated to the subsequent user by a subsequent web server.

8. A system for providing secure access to a service on a service web server comprising:
a permission web server that maintains a first permission, wherein the first permission comprises a label related to the service and a digital signature of a first user; that provides a second user access to the first permission upon the second user authenticating to the permission web server; and that provides to the second user a permission comprising the first permission and a permission link comprising the label and a digital signature of the permission web server; and
the service web server that receives from a subsequent user a request to access the service and a subsequent permission, comprising the permission, the subsequent user having been delegated the subsequent permission; that verifies at least the digital signature of the permission web server and the digital signature of the first user in the permission; and that provides the subsequent user access to the service if the verification produces a positive result.
